(19) United States
(12) Patent Application Publication
(10) Pub. No.: US 2015/0367491 A1
(43) Pub. Date: Dec. 24, 2015

(54) SILENCING DEVICE FOR PNEUMATIC TOOL

(71) Applicant: TRANMAX MACHINERY CO., LTD., Taichung City (TW)

(72) Inventor: Hsin-Chi CHEN, Taichung City (TW)

(21) Appl. No.: 14/535,074

(22) Filed: Nov. 6, 2014

(30) Foreign Application Priority Data
Jun. 24, 2014 (TW) 103121695

(51) Int. Cl. B25D 17/12

(52) U.S. Cl. CPC B25D 17/12

(57) ABSTRACT

A silencing device is disposed in an exhaust channel of a pneumatic tool. The exhaust channel has an outlet and an inner surface. The silencing device includes a shell-shaped silencer made of a porous material and a silencing washer disposed between the silencer and the inner surface of the exhaust channel. The silencer includes an open end, a closed end, an annular wall located between the open end and the closed end, and a concave portion located on the inner side of the annular wall. The open end is closer to the outlet of the exhaust channel than the closed end. The annular wall extends substantially along the inner surface of the exhaust channel. Therefore, the silencing device can lead to preferable effects of noise reduction and dust prevention and apply minimal adverse effect on the driving power of the pneumatic tool.

### BACKGROUND OF THE INVENTION

1. Technical Field

The present disclosure relates to a silencing device and in particular to a silencing device for a pneumatic tool.

2. Description of Related Art

A general pneumatic tool includes a case having an air supply channel and an air exhaust channel, a motor disposed inside the case, and an output shaft protruding outward from the case and being driven to rotate by the motor. When the pneumatic tool is activated, the compressed air enters the air supply channel and flows through a specific gas flow path to drive the motor to rotate the output shaft. Next, the compressed air exhausts through the air exhaust channel from the case.

Great noise is generated while the compressed air exhausts from the case, so a silencer is usually disposed at an outlet of the air exhaust channel A traditional silencer for the pneumatic tool is usually a buffer block made of a buffer-based material (e.g. foam sponge, wool felt, non-woven fabric) and is plugged into the outlet. The buffer block can reduce noise but lead to great resistance against the exhaustion inside the pneumatic tool to adversely affect the amplitude of the driving power outputted by the pneumatic tool. In addition, the pneumatic tool usually requires a preferable dustproof effect. Apart from 0-shaped rings or oil seals disposed in openings, rotatable parts, and movable parts for dustproof effect, the air exhaust channel also needs to be dustproof. The silencer of the pneumatic tool though needs pores for the air to pass through, but the pores of the above-mentioned buffer block are so big that the impurity and dust in the environment, in particular roads, mining area, or places having more dust, can easily enter the case of the pneumatic tool via the pores to impair the performance of the pneumatic tool and even damage its inner components.

### SUMMARY OF THE INVENTION

A primary objective of the present disclosure is to provide a silencing device for pneumatic tool; the silencing device has preferable effects of noise reduction and dust prevention with little adverse effect on the driving power of the pneumatic tool.

To attain the foregoing objective of the present disclosure, the silencing device is disposed in an exhaust channel of a pneumatic tool. The exhaust channel has an outlet and an inner surface. The silencing device includes a silencer made of a porous material. The silencer is shell-shaped and has an open end, a closed end, an annular wall located between the open end and the closed end, and a concave portion located at an inner side of the annular wall. The open end is closer to the outlet of the exhaust channel than the closed end. The annular wall extends substantially along the inner surface of the exhaust channel.

Therefore, the silencer can be made of but not limited to metallic powder particles (e.g. copper powder particle) by powder metallurgy, thus leading to a structure of smaller pores and preferable effects of noise reduction and dust prevention. The silencer has the concave portion and the annular wall extends substantially along the inner surface of the exhaust channel, so the silencer can have very large area in contact with the compressed air within the exhaust channel and a lot of pores are available for the compressed air to pass through. In addition, the silencer is hollow to cause less resistance against the compressed air inside the exhaust channel, so the adverse effect on the output driving power of the pneumatic tool is less.

In order to further understand the techniques, means and effects of the present disclosure, the following detailed descriptions and appended drawings are hereby referred, such that, through which, the purposes, features and aspects of the silencing device for pneumatic tool of the present disclosure can be thoroughly and concretely appreciated; however, the appended drawings are merely provided for reference and illustration, without any intention to be used for limiting the present disclosure.

### BRIEF DESCRIPTION OF THE DRAWINGS

FIG. 1 is a partially sectional view of a pneumatic tool having a silencing device of a preferred embodiment of the present disclosure;

FIG. 2 is a sectional view taken along a line 2-2 indicated in FIG. 1;

FIG. 3 is a sectional view taken along a line 3-3 indicated in FIG. 1; and

FIG. 4 and FIG. 5 are exploded views of the silencing device of the preferred embodiment of the present disclosure at different angles.

### DETAILED DESCRIPTION OF PREFERRED EMBODIMENTS

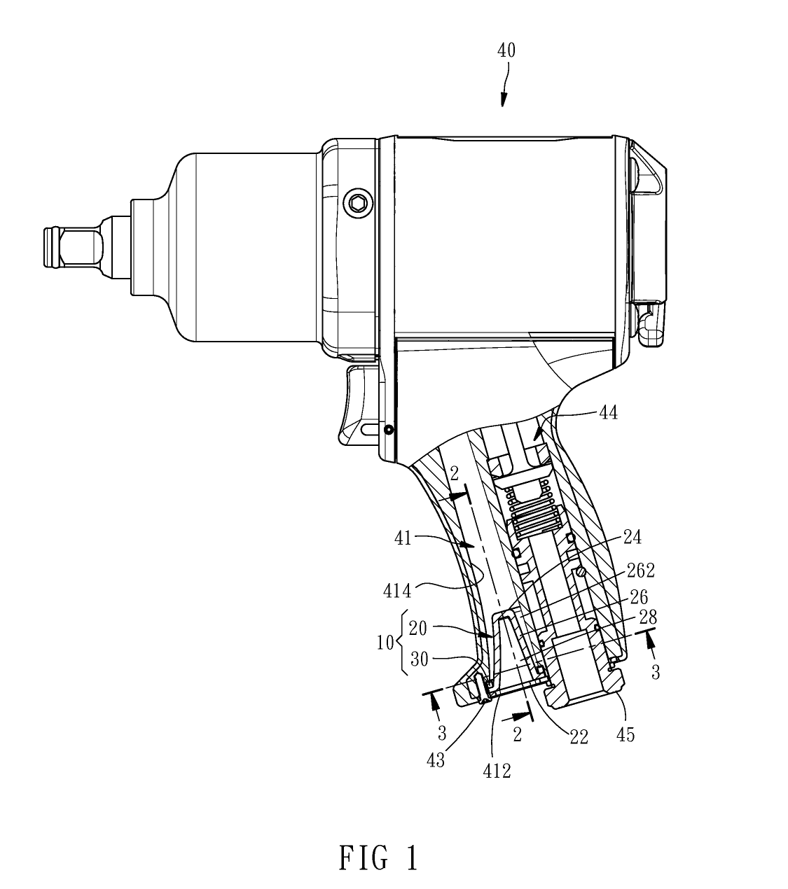

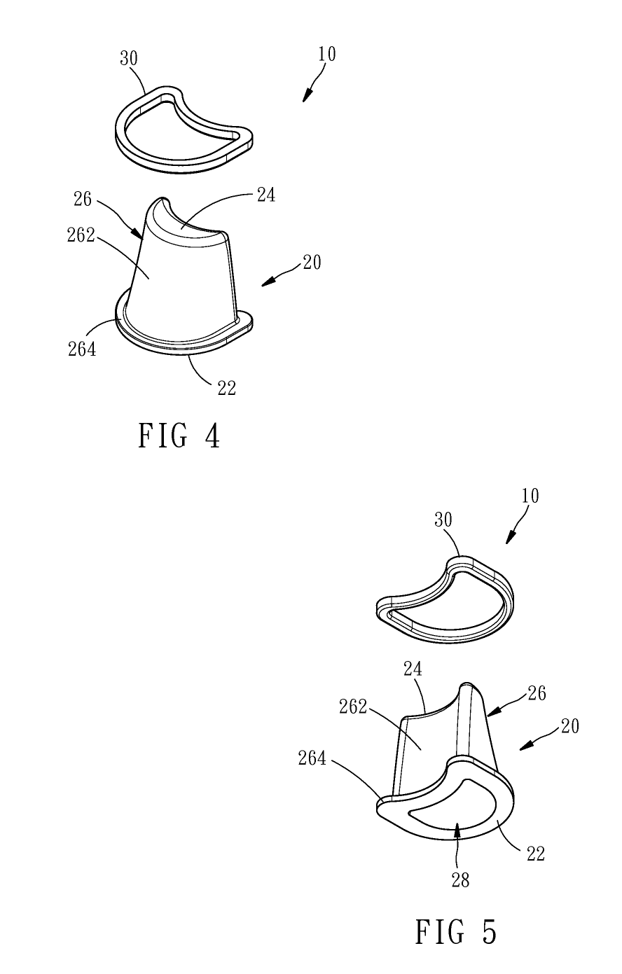

Referring to FIGS. 1-5, the silencing device 10 constructed according to a preferred embodiment of the present disclosure includes a silencer 20 and a silencing washer 30. The silencing device 10 is disposed in an exhaust channel 41 of a pneumatic tool 40. The exhaust channel 41 has an outlet 412 and an inner surface 414.

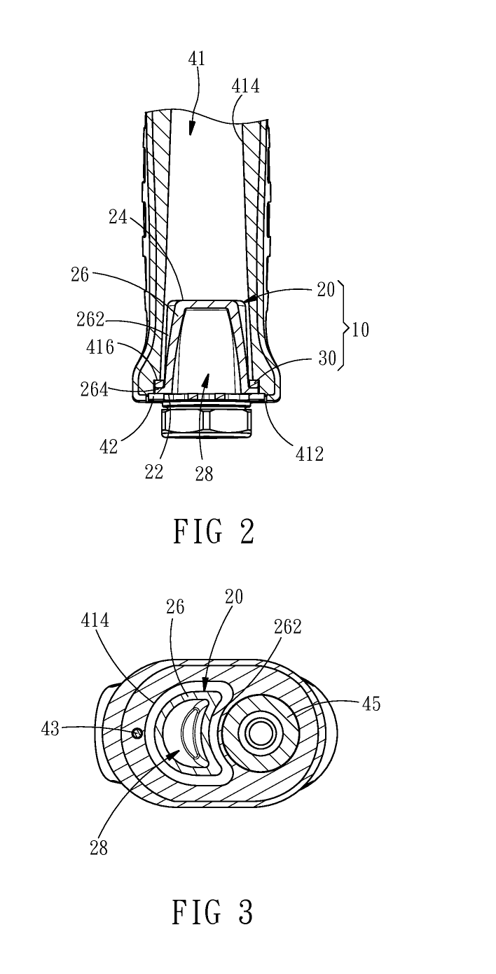

In this exemplary embodiment, the exhaust channel 41 has a stepped portion 416 located at the outlet 412 and on the inner surface 414, as shown in FIG. 2. The silencing device 10 is pressed against the stepped portion 416 by an exhaust cover 42. The exhaust cover 42 is fixed by a screw 43 and a tube connector 45 disposed in an air supply channel 44 for fastening the silencing device 10 to the outlet 412. However, the fixing manner for the silencing device 10 is not limited to that of this preferred embodiment, and the location of the silencing device 10 is not limited to the outlet 412.

The silencer 20 is shell-shaped and has an open end 22, a closed end 24, an annular wall 26 positioned between the open end 22 and the closed end 24, and a concave portion 28 located on an inner side of the annular wall 26. The silencer 20 is made of a porous material. For example, the silencer 20 can be made of metallic powder particles (e.g. copper powder particles) by powder metallurgy or either of other metals or nonmetal materials (e.g. fine non-woven fabric). The silencing washer 30 is made of a soft elastic material (e.g. rubber, cushion, etc.) and has a shape corresponding to the annular wall 26.

When the silencing device 10 is disposed in the exhaust channel 41, the silencing washer 30 is disposed between the silencer 20 and the inner surface 414 of the exhaust channel 41. The open end 22 is closer to the outlet 412 of the exhaust channel 41 than the closed end 24, so the opening of the concave portion 28 faces an external side of the exhaust channel 41. In addition, the annular wall 26 substantially extend along the inner surface 414 of the exhaust channel 41; that is, the extension direction of the annular wall 26 is substantially the same as that of the exhaust channel 41.

In this exemplary embodiment, the annular wall 26 of the silencer 20 has an outer surface 262 and a flange 264 protruding outward from the outer surface 262. The flange 264 is located at the open end 22. The silencing washer 30 is sleeved onto the silencer 20 and disposed between the flange 264 and the stepped portion 416 of the inner surface 414 of the exhaust channel 41; that is, the flange 264 is fixed on the inner surface 414 of the exhaust channel 41 with the silencing washer 30 located between the silencing washer 30 and the inner surface 414. Therefore, only the flange 264 of the annular wall 26 contacts the inner surface 414 of the exhaust channel 41, and other parts of the annular wall 26 are spaced from the inner surface 414, so the outer surface 262 of the annular wall 26 faces the inner surface 414 with an interval therebetween. However, the annular wall 26 is not limited to the design of being spaced from the inner surface 414 and the outer surface 262 of the annular wall 26 can also contact the inner surface 414.

In the silencing device 10 of the present disclosure, the silencer 20 can reduce the noise caused by the compressed air exhausting through the exhaust channel 41, and the silencing washer 30 can enhance the effect of noise reduction of the silencing device 10. However, the silencing device 10 can fasten the silencer 20 other than the silencing washer 30 to the inner surface 414 of the exhaust channel 41. The annular wall 26 of the silencer 20 substantially extends along the inner surface 414 of the exhaust channel 41 and such design makes the area of the silencer 20 in contact with the compressed air inside the exhaust channel 41 larger, so more pores are available for the compressed air to pass through. In addition, the silencer 20 is hollow to apply less resistance to the compressed air inside the exhaust channel 41. Therefore, the silencer 20 can be made to have smaller pores to achieve the preferable dustproof effect with less adverse effect on the output driving power of the pneumatic tool 40.

As already stated above, the silencer 20 of this preferred embodiment is designed to make the outer surface 262 of the annular wall 26 spaced from the inner surface 414 of the exhaust channel 41 for a distance, so the silencer 20 can provide more pores for the compressed air to pass through and the output driving power of the pneumatic tool 40 can be further adversely affected minimally. In particular, the annular wall 26 corresponds to the inner surface 414 of the exhaust channel 41 in shape to make every part of the outer surface 262 spaced from the inner surface 414 for the same distance, so the resistance against the compressed air inside the exhaust channel 41 as caused by the silencer 20 can be further reduced. In addition, each of the pores of the silencer 20 is preferably smaller than 0.05 mm in diameter for very preferable dustproof effect, e.g. IP6X dustproof test is passed. For example, if the silencer 20 is made by powder metallurgy, the diameter of every metallic powder particle of the silencer 20 can be 0.04 mm to meet the standard which has preferable dustproof effect.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A silencing device for a pneumatic tool, the silencing device being disposed in an exhaust channel of the pneumatic tool, the exhaust channel having an outlet and an inner surface, the silencing device comprising:
a shell-shaped silencer made of a porous material and having an open end, a closed end, an annular wall located between the open end and the closed end, and a concave portion located at an inner side of the annular wall, the open end being closer to the outlet of the exhaust channel than the closed end, the annular wall extending along the inner surface of the exhaust channel.

2. The silencing device as defined in claim 1, wherein the annular wall of the silencer has an outer surface and a flange protruding outward from the outer surface, the flange being fixed to the inner surface of the exhaust channel to enable the outer surface to face the inner surface in an interval therebetween.

3. The silencing device as defined in claim 2 further comprising a silencing washer, wherein the silencing washer is disposed between the flange of the silencer and the inner surface of the exhaust channel.

4. The silencing device as defined in claim 1, wherein the annular wall of the silencer corresponds to the inner surface of the exhaust channel in shape.

5. The silencing device as defined in claim 1, wherein every pore of the silencer is smaller than 0.05 mm in diameter.

6. The silencing device as defined in claim 1, wherein the silencer is made of metallic powder particles.

7. The silencing device as defined in claim 6, wherein the silencer is made of copper powder particles.

8. The silencing device as defined in claim 6, wherein each of of the metallic powder particles of the silencer is 0.04 mm in diameter.

9. The silencing device as defined in claim 1, wherein the silencer is made by powder metallurgy.

10. The silencing device as defined in claim 1 further comprising a silencing washer, wherein the silencing washer is disposed between the silencer and the inner surface of the exhaust channel.
